(19) United States
(12) Patent Application Publication
(10) Pub. No.: US 2013/0129971 A1
(43) Pub. Date: May 23, 2013

(54) Rotating Label Support System for a Container

(71) Applicants: Stephen M. Key, Modesto, CA (US); Richard J. Haskins, Singer Island, FL (US)

(72) Inventors: Stephen M. Key, Modesto, CA (US); Richard J. Haskins, Singer Island, FL (US)

(21) Appl. No.: 13/622,312

(22) Filed: Sep. 18, 2012

Related U.S. Application Data
(60) Provisional application No. 61/536,452, filed on Sep. 19, 2011.

(51) Int. Cl. B32B 3/08; G09F 3/00; B32B 3/04

(52) U.S. Cl. CPC B32B 3/085; B32B 3/04; G09F 3/0288
USPC 428/121; 156/60; 428/192

(57) ABSTRACT

The present application is directed to rotating label support systems for a container and methods thereof. A base label may be adhered to the container. A rotating top label may cover at least a portion of the base label. The support system may comprise one or more support members that restrict linear movement of the top label while allowing rotational movement of the top label.

### CROSS-REFERENCE TO RELATED APPLICATIONS

The present application claims priority to provisional U.S. Patent Application Ser. No. 61/536,452, filed on Sep. 19, 2011, titled “Rotating Label System and Method, Including Inner Shell with Rail/Rim System to Hold Outer Rotating Shell in Place,” which is hereby incorporated by reference in its entirety.

### FIELD OF THE INVENTION

The present application is directed generally to labels, and more specifically to dual-ply label systems for consumer product containers.

### BACKGROUND

Containers for consumer products have a limited amount of outer surface area for placement of labels on the container. This may pose a challenge to manufacturers of these consumer products to fit all of the information they want to deliver to the consumer, or are required by law to deliver to the consumer, in this limited area. In particular, packaging for prescription medications may specify a significant amount of information concerning the condition the medication is intended to treat, as well as the effects of consuming the medication.

Manufacturers may use expanded content label systems to deliver the required information to the consumer. A portion of these label systems may comprise a moveable label. Such labels may require containers specifically designed for their use, which may significantly increase the cost of the product to the consumer. Many consumer products use standardized packaging which may not readily accommodate expanded content labels.

### SUMMARY

The present application is directed to rotating label support systems for a container. An exemplary support system may comprise a base label adhered to the container. The base label may have a back surface and a front surface, with indicia printed on the front surface. The support system for the rotating label system may further comprise an opaque rotating top label covering at least a portion of the front surface of the base label. The opaque rotating top label may be rotatable about the base label. In various embodiments, the opaque rotating top label may have at least one transparent within the top label indicia printed in the front surface of the base label to be visible through the transparent window. The support system may further comprise first and second support members coupled to the base label. The support members may restrict linear movement of the top label while allowing rotational movement of the top label about the container.

According to additional exemplary embodiments, the present application may be directed to methods for supporting a rotating label system on a container. An exemplary method may comprise adhering a base label having a back surface and a front surface to the container, with indicia placed on the front surface of the base label. At least a portion of the front surface of the base label may be covered by an opaque rotating top label. A transparent window may be placed within the opaque rotating top label, such that at a portion of the indicia may be visible through the transparent window. First and second support members may be coupled to the base label adjacent to a lower and upper edge, respectively, of the base label. The first and second support members may restrict linear movement of the top label while allowing rotational movement of the top label.

### BRIEF DESCRIPTION OF THE DRAWINGS

FIG. 1 is a front view of an exemplary label according to various embodiments.

FIG. 2 is a back view of an exemplary label according to various embodiments.

FIG. 3 is a front view of an exemplary label according to various embodiments.

FIG. 4 is a back view of an exemplary label according to various embodiments.

FIG. 5A illustrates a leading edge of an exemplary label affixed to a container according to various embodiments.

FIG. 5B illustrates an exemplary label secured about a container according to various embodiments.

FIG. 6 illustrates an exemplary label secured about a container according to various embodiments.

FIG. 7 illustrates an exemplary base label secured about a container according to various embodiments.

FIG. 8 illustrates a leading edge of an exemplary top label affixed to an exemplary base label according to various embodiments.

FIG. 9 illustrates an exemplary top label affixed to an exemplary base label and partially wrapped about a container according to various embodiments.

FIG. 10 illustrates an exemplary top label with a window affixed to an exemplary base label and partially wrapped about a container according to various embodiments.

FIG. 11 illustrates an exemplary top label with a window secured about a container and a portion of a base label visible through the window according to various embodiments.

FIG. 12 illustrates a front view of a container according to various embodiments.

FIG. 13 illustrates a schematic view of an exemplary rotating label support system according to various embodiments.

FIG. 14 illustrates a schematic view of an exemplary rotating label support system according to various embodiments.

FIG. 15 illustrates a front view of an exemplary base label according to various embodiments.

FIG. 16 illustrates a front view of an exemplary base label according to various embodiments.

FIG. 17 illustrates a front view of an exemplary base label and a substrate material according to various embodiments.

FIG. 18 illustrates a front view of an exemplary base label with a portion of a substrate material being removed according to various embodiments.

FIG. 19 illustrates a side view of an exemplary base label according to various embodiments.

FIG. 20 illustrates a front view of an exemplary base label adhered to a container according to various embodiments.

FIG. 21 illustrates an exemplary base label secured about a container according to various embodiments.

FIG. 22 illustrates a front view of an exemplary base label adhered to a container according to various embodiments.

FIG. 23 illustrates an exemplary base label secured about a container according to various embodiments.

FIG. 24 illustrates an exemplary top label according to various embodiments.

FIG. 25 illustrates an exemplary base label and top label secured about a container according to various embodiments.

FIG. 26 illustrates an exemplary base label and top label secured about a container according to various embodiments

FIG. 27A illustrates an exemplary base label and top label secured about a container according to various embodiments.

FIG. 27B illustrates an exemplary base label and top label secured about a container according to various embodiments.

FIG. 27C illustrates an exemplary base label and top label secured about a container according to various embodiments.

FIG. 28 illustrates an exemplary base label coupled to a top label according to various embodiments.

FIG. 29 illustrates an exemplary base label coupled to a top label, and a substrate material according to various embodiments.

FIG. 30 illustrates an exemplary base material coupled to a top label with a portion of the substrate material being removed according to various embodiments.

FIG. 31 illustrates an exemplary base label coupled to a top label and secured to a container according to various embodiments.

FIG. 32 illustrates an exemplary base label and top label secured about a container according to various embodiments.

FIG. 33 illustrates an exemplary base label and top label secured about a container according to various embodiments.

FIG. 34 illustrates an exemplary base label and top label secured about a container according to various embodiments.

FIG. 35 illustrates a front view of an exemplary base label according to various embodiments.

FIG. 36 illustrates a side view of an exemplary base label according to various embodiments.

FIG. 37 illustrates a front view of an exemplary base label according to various embodiments.

FIG. 38 illustrates a side view of an exemplary base label according to various embodiments.

FIG. 39 illustrates a front view of an exemplary base label according to various embodiments.

FIG. 40 illustrates a front view of an exemplary base label according to various embodiments.

FIG. 41 illustrates a front view of an exemplary base label according to various embodiments.

FIG. 42 illustrates a front view of an exemplary base label according to various embodiments.

FIG. 43 illustrates a side view of an exemplary base label according to various embodiments.

FIG. 44 is an exemplary flow diagram of a method for supporting a rotating label system for a container according to various embodiments.

### DETAILED DESCRIPTION

The present application is directed to rotating label support systems for a container. An exemplary support system may comprise a base label adhered to the container. The base label may have a back surface and a front surface, with indicia printed on the front surface. The support system for the rotating label system may further comprise an opaque rotating top label covering at least a portion of the front surface of the base label. The opaque rotating top label may be rotatable about the base label. In various embodiments, the opaque rotating top label may have at least one transparent within the top label indicia printed in the front surface of the base label to be visible through the transparent window. The support system may further comprise a first support members coupled to the base label adjacent to a lower edge of the base label and a second support member coupled to the base label adjacent to an upper edge of the base label. The support members may restrict linear movement of the top label while allowing rotational movement of the top label about the container.

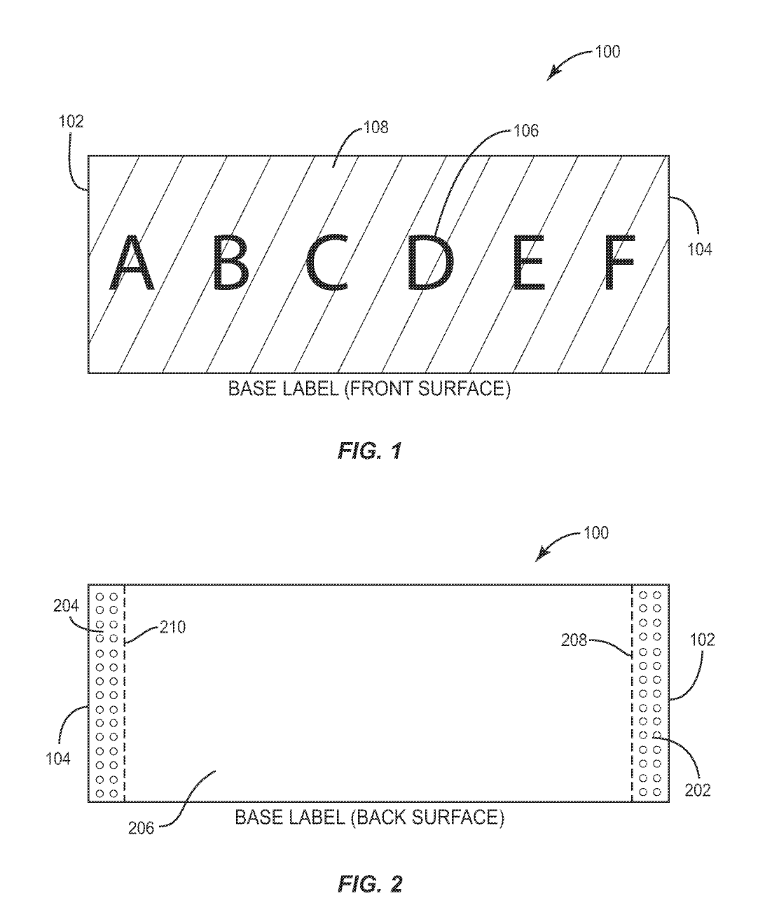

FIG. 1 illustrates various embodiments of a front surface 108 of a base label 100 for an object, such as a medication container, according to various embodiments. The base label 100 comprises a leading edge 102 and a trailing edge 104. While the leading edge 102 is oriented to the left and the trailing edge is oriented to the right as presented in FIG. 1, the orientation of the leading edge 102 and the trailing edge 104 could be reversed depending on which edge is first applied to the object. Both orientations are within the scope of the present disclosure. Base label front surface 108 may comprise writing or other indicia 106 thereon.

As used herein, the leading edge refers to the first edge to be affixed to the object and the trailing edge refers to the second edge to be affixed to the object or the overlapping leading edge. Depending on the orientation of the label and the object when the label is affixed to the object, either edge of the label may be the leading edge. The orientations presented in the figures are for convenience and are not intended to be limiting in any way.

FIG. 2 illustrates various embodiments of a back surface 206 of the base label 100. In various embodiments, the base label back surface 206 comprises two strips of adhesive 202 and 204 on or immediately adjacent to the leading and trailing edges, 102 and 104, respectively. Base label leading edge adhesive 202 may have a boundary 208 defined as its limit on the base label back surface 206. Base label trailing edge adhesive 204 may also have a boundary 210. While FIG. 2 illustrates that the adhesive strips 202 and 204 are generally close to the base label leading and trailing edges 102 and 104, respectively, it is understood that the adhesive strips 202 and 204 may be continuous or discontinuous, and may extend across any portion of the base label back surface 206, including the entire base label back surface 206. In various embodiments, a length of the base label 100 may be selected to be slightly longer than a circumference of the object on which it is placed, such that the trailing edge 104 overlaps the leading edge 102, and the trailing edge 104 is affixed to the leading edge 102. In various embodiments, the length of the base label 100 may be selected to be approximately the same as the circumference of the object on which it is placed, such that the leading edge 102 and the trailing edge 104 do not overlap.

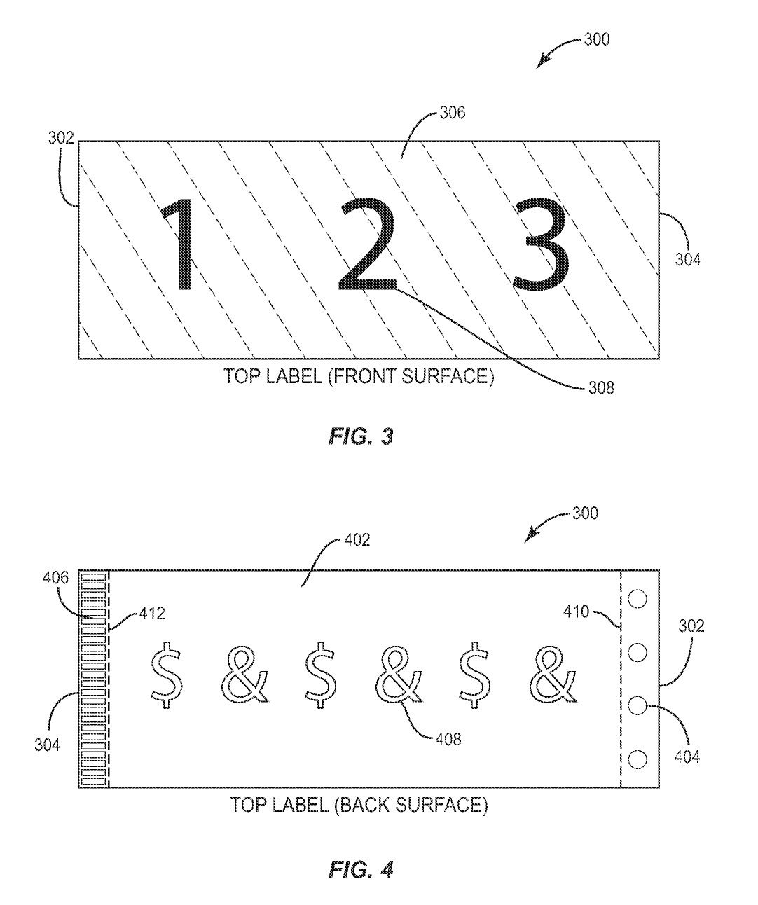

FIG. 3 illustrates various embodiments of a front surface 306 of a top label 300. Top label 300 comprises a leading edge 302 and a trailing edge 304, and indicia 308 may be imprinted on the top label front surface 306.

Various embodiments of a back surface 402 of the top label 300 are illustrated in FIG. 4. The top label back surface 402 may comprise various indicia 408 printed thereon, as well as two strips of adhesive 404 and 406 on or immediately adjacent to the leading and trailing edges, 302 and 304, respectively. Top label leading edge adhesive 404 may have a boundary 410 defined as its limit on the top label back surface 402. Top label trailing edge adhesive 406 may also have a boundary 412. While FIG. 4 illustrates that the adhesive strips 404 and 406 are generally close to the top label leading and trailing edges 302 and 304, respectively, it is understood that the adhesive strips 404 and 406 may be continuous or discontinuous, and may extend across any portion of the top label back surface 402, including the entire top label back surface 402. In various embodiments, the adhesive strips 404 and 406 are confined to areas near the leading and trailing edges 302 and 304, respectively, so as not to obscure or interfere with the top label back surface indicia 408.

The base label adhesive 202, 204 and the top label adhesive 404, 406 may be applied in a variety of patterns as can be appreciated by one skilled in the art. The adhesive 202, 204, 404, 406 may be applied in in strips, dots, droplets, circles, rectangles, squares, triangles, lines, and the like, as well as combinations of patterns.

A length of the top label 300 may be selected to be slightly longer than a circumference of the object on which it is placed, such that the top label trailing edge 304 overlaps the top label leading edge 302, and the top label trailing edge 304 is affixed to the top label leading edge 302. In various embodiments, the length of the top label 300 may be selected to be approximately the same as the circumference of the object on which it is placed, such that both the leading edge 302 and the trailing edge 304 do not overlap and are affixed to the base label front surface 108.

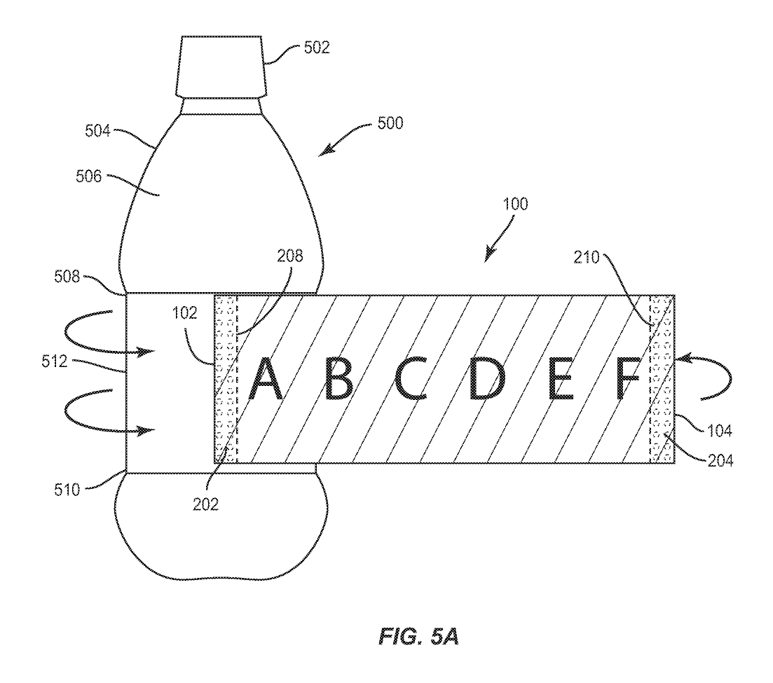

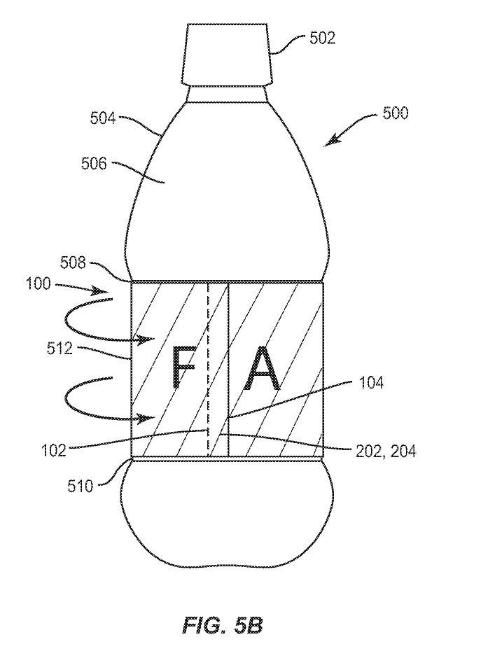

FIG. 5A illustrates the application of the base label 100 to an exemplary container 500 according to various embodiments. The container 500 may be a glass or plastic bottle, or other type of container such as a metal can or a cardboard receptacle. The container may be round, rectangular, square, or any other shape known in the art. The term “container” is used here for convenience to describe exemplary embodiments. It is understood that the container may be any object, including non-containers. Container 500 may comprise a cap 502 removably secured to a body 504. Various embodiments of the body 504 may have an exterior surface 506 that comprises a upper label panel 508, a lower label panel 510, and a recessed surface 512 interposed between the upper label panel 508 and the lower label panel 510. As discussed below, the base label 100 may be applied to the container 500 at the recessed area 512 between the upper label panel 508 and the lower label panel 510.

In various embodiments, the top label 300 may be rotatable about the base label 100, as discussed below. In these embodiments, the upper label panel 508 and lower label panel 510 may function to restrict upward and downward movement of the top label 300 in relation to the container 500 such that the top label 300 generally remains in a position covering at least a portion of the base label 100.

FIG. 5B illustrates the container 500 with the base label 100 affixed to the container 500. Initially, as illustrated in FIG. 5A, base label leading edge 102 is placed in contact with the recessed surface 512 of the container 500 and affixed to the container 500 by the leading edge adhesive strip 202. With relative motion between the container 500 and the base label 100, the base label 100 may be wrapped around the container 500 with the base label trailing edge 104 now overlapping the base label leading edge 102 such that the leading edge adhesive strip 202 holds the base label leading edge 102 to the container 500 while the trailing edge adhesive strip 204 holds the base label trailing edge 104 to the overlapped base label leading edge 102.

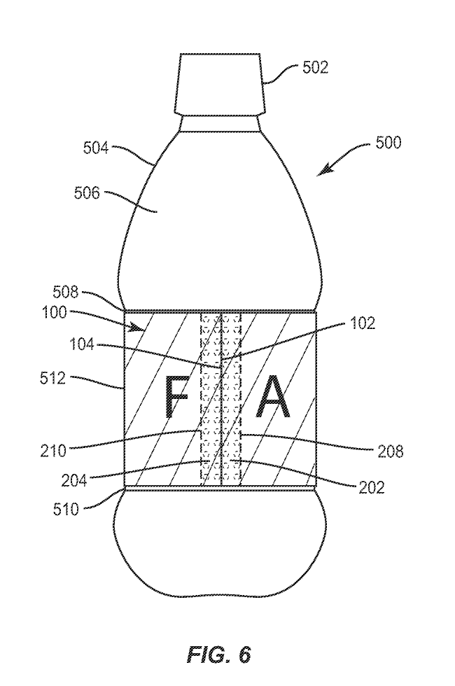

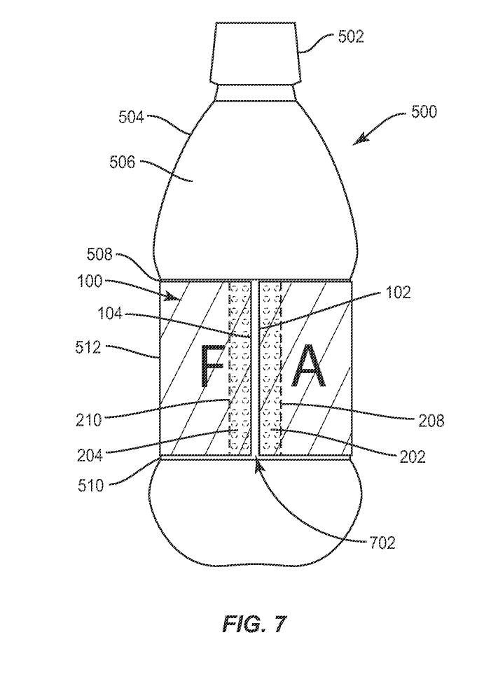

In various embodiments as illustrated in FIG. 6, the length of the base label 100 may be substantially the same as a circumference of the recessed surface 512 of the container 500, which may allow the base label leading edge 102 and base label trailing edge 104 to abut rather than overlap. However, it is also possible that the length of the base label 100 may be shorter than the circumference of the recessed surface 512, resulting in a gap 702 between the base label leading edge 102 and the base label trailing edge 104 when the base label 100 is affixed to the recessed surface as illustrated in FIG. 7. In both of these instances, the base label trailing edge adhesive strip 204 may adhere to the recessed surface 512 of the container 500, rather than the base label leading edge 102.

In various embodiments, the base label adhesive strips 202, 204 may comprise a permanent adhesive. In general, a permanent adhesive is one that does not readily release from a surface to which it adheres after the adhesive dries or cures. Using the base label 100 as an example, the permanent adhesive 202, 204 will tend not to release from the recessed surface 512, nor will it tend to release the base label leading edge 102 or trailing edge 104 once dried or cured. In order to remove the base label from the recessed surface 512, the base label 100 may have to be torn from the adhesive, or the adhesive layer 202, 204 may have to be fractured which may leave some of the adhesive on the recessed surface 512 and some of the adhesive on the base label leading edge 102 or trailing edge 104. Once the surfaces affixed with the permanent adhesive are separated, they may not be reattached.

In FIG. 8, the base label 100 is already affixed to the recessed surface 512 of the container 500, and the application of the top label 300 over the base label 100 is illustrated according to various embodiments. The top label leading edge 302 may be placed in contact with any portion of the base label front surface 108 and affixed to the base label front surface 108 by the top label leading edge adhesive strip 404. With relative motion between the container 500 and the top label 300, the top label 300 may be wrapped around the container 500 with the top label trailing edge 304 now overlapping the top label leading edge 302 such that the top label leading edge adhesive strip 404 holds the top label leading edge 302 to the base label 100 while the top label trailing edge adhesive strip 406 holds the top label trailing edge 304 to the overlapped top label leading edge 302.

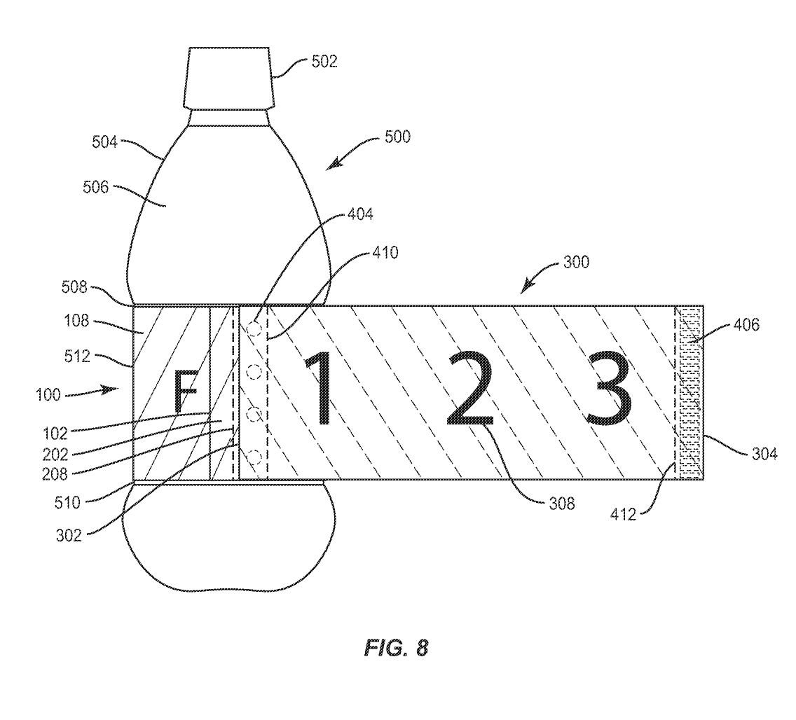

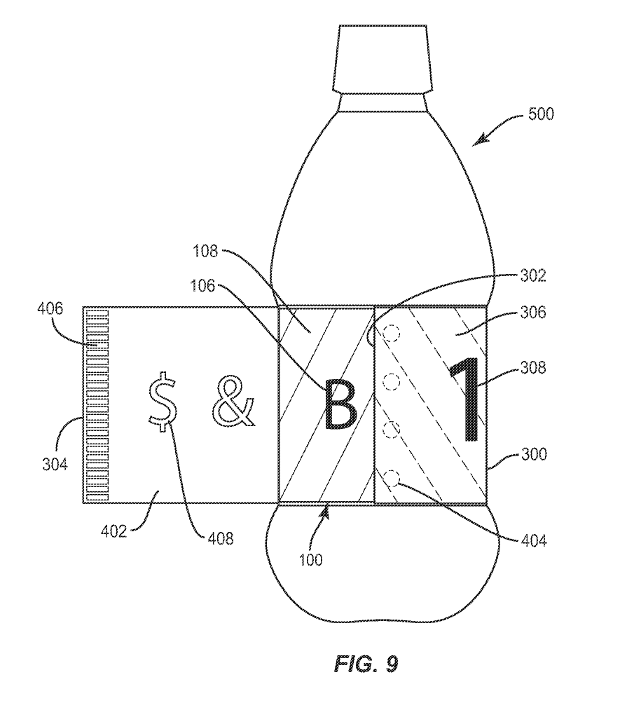

FIG. 9 illustrates the operation of the base label 100 and the top label 300 according to various embodiments. Beginning with the container 500 with the base label 100 and the top label 300 in place as shown, for example, in FIG. 6, the top label trailing edge 304 may be detached from the top label leading edge 302 and at least partially peeled back as shown in FIG. 9. The combination of the base label 100 and the top label 300 in this configuration increases the amount of surface area available for viewing by a consumer or user of the container 500. Prior to detaching the top label trailing edge 304, the consumer may view the top label front surface 306. Upon detaching the top label trailing edge 304, the consumer may now view the top label back surface 402 and the base label front surface 108 in addition to the top label front surface 306.

One of at least three types of adhesive may be used for the top label leading edge adhesive 404. A first type of adhesive is the permanent adhesive as described above for the base label 100. When a permanent adhesive is used for the top label leading edge adhesive 404, the top label leading edge generally cannot be detached without inflicting damage to one or both of the top label 300 or the base label 100. This may be desirable for various embodiments where the top label 300 is not intended to be removed from the container 500.

A second type of adhesive that may be used for the top label leading edge adhesive 404 is a releasable adhesive. A releasable adhesive is one that will release from a surface to which it is attached once a sufficient mechanical force is applied. A releasable adhesive may be used, for example, when the top label back surface 402 comprises a coupon for a subsequent purchase of a product. The releasable adhesive may allow the consumer to easily remove the top label 300 for later use. In various embodiments, the releasable adhesive may be a breakaway adhesive. A breakaway adhesive may have limited ability to withstand shear stresses. Shear stresses may cause the adhesive bond created between the label (e.g., top label 300) and the surface to which it is affixed (e.g., the base label 100 or container 500) to fail along the adhesive. In general, a releasable or breakaway adhesive may not re-attach to a surface once removed.

A third type of adhesive that may be used for the top label leading edge adhesive 404 is a resealable adhesive. A resealable adhesive may release from a surface to which it is attached once a sufficient mechanical force is applied, similar to the releasable adhesive described above. However, the resealable adhesive may be re-attached to a surface by applying pressure. A resealable adhesive may be desirable when the top label back surface 402 or the base label front surface 108 comprise information that may be needed only on occasion. Thus, the consumer or user may detach the top label 300 when the information is needed, then re-attach the top label 300.

In various embodiments, the top label trailing edge adhesive 406 may be a releasable adhesive or a resealable adhesive, depending on the intended use of the top label 300. As described above, if the surfaces 108, 402 comprise information that is intended to stay with the container, the top label trailing edge adhesive 406 may be a resealable adhesive. In contrast, if the top label 300 is intended to be removed from the container 500, a releasable adhesive may be desirable.

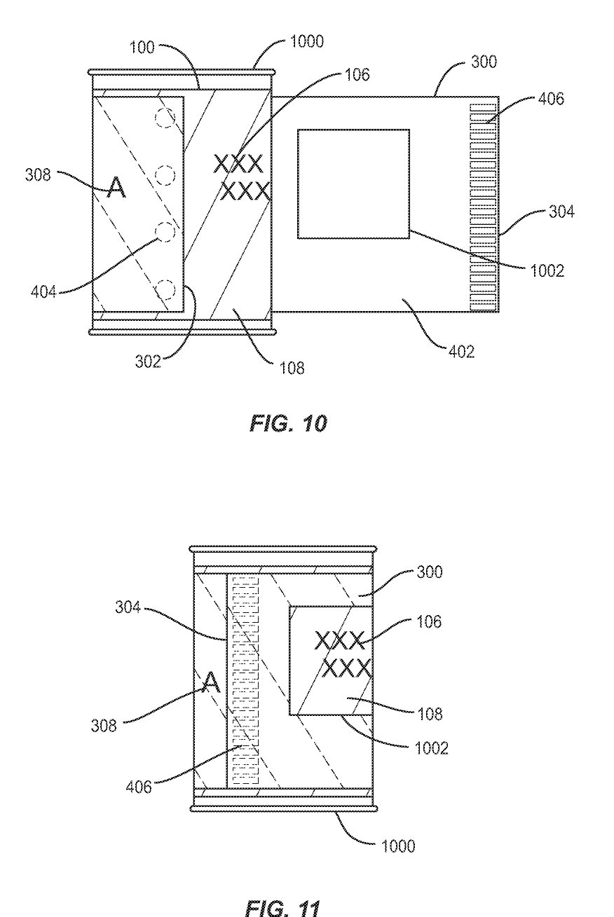

FIG. 10 illustrates various embodiments of the top label 300 comprising a window 1002. The window 1002 may comprise a void in the top label 300 such that a portion of the base label 100 may be visible through the window. In various embodiments, the window 1002 may have a transparent covering (not shown). In various other embodiments, the window may comprise a transparent section of the top label 300 itself rather than a void. FIG. 10 illustrates the top label 300 partially wrapped about a container 1000, and base label 100 already in place on the container 1000. As shown, the top label leading edge adhesive 404 maintains the top label 300 coupled to the base label 100. The top label 300 may then be moved from the position illustrated in FIG. 10 to the position illustrated in FIG. 11 to secure the top label 300 about the container 1000. Top label trailing edge adhesive 406 may couple to the top label leading edge 302 if the top label leading edge 302 and trailing edge 304 overlap; otherwise, the top label trailing edge adhesive 406 may be coupled to the base label front surface 108.

Once the top label 300 is in position on the container 1000 as illustrated in FIG. 11, at least a portion of the base label front surface indicia 106 may be visible through the window 1002. This may allow viewing of a first portion of the base label 100 without removing the top label 300. In various embodiments, the top label leading edge adhesive 404 may be a breakaway adhesive. Rotation of the top label 300 relative to the base label 100 may exert shear stresses on the breakaway adhesive, causing the adhesive bond affixing the top label leading edge 302 to the base label 100 to fail. The top label 300 may then be freely rotatable about the base label 100, and a second portion of the base label 100 may be visible when the top label 300 is rotated to a second position. The window 1002 may be rectangular as illustrated in FIGS. 10 and 11, or any other shape as needed for a particular application. For example, the window 1002 may be a slit that reveals an alphanumeric string on the base label 100. In various embodiments, the top label 300 may comprise more than one window 1002. Various embodiments in which the top label trailing edge adhesive 406 is a resealable or releasable adhesive may allow the top label 300 to be peeled back to reveal the top label back surface 402 and essentially the entire base label front surface 108 or to be removed from the container 1000, in addition to being rotatable.

One skilled in the art will readily recognize that labels may be applied to containers using a variety of methods and that there may be a variety of single-label and multi-label systems other than those described above. Any such application methods or label systems may be used with the present disclosure. The above descriptions are exemplary and not to be construed as limiting in any way. Examples of other application methods and label systems may be disclosed in U.S. Pat. Nos. 5,884,421, 6,086,697, 6,237,269, 6,402,872, 6,631,578, 6,649,007, 7,087,298, and 7,172,668.

In the embodiments described above, the container, such as container 500 in FIG. 5A, may comprise an upper label panel 508, a lower label panel 510, and a recessed surface 512 interposed between the upper label panel 508 and the lower label panel 510. This structure may restrain the top label 300 from linear movement (i.e., non-rotational) along a vertical axis of the container 500. For example, the upper label panel 508 may restrict the top label 300 from moving linearly upward (according to the orientation in FIG. 5A) along the vertical axis of the container 500. Likewise, the lower label panel 510 may restrict the top label from moving linearly downward along the vertical axis of the container 500. However, the upper and lower label panels 508, 510 may offer little or no resistance to rotational movement of the top label 300 about the container 500. Other containers, such as the container 1000 in FIG. 10, may comprise analogous structures to restrict linear movement of the top label 300, such as the lip of the top and bottom lids of the container 1000.

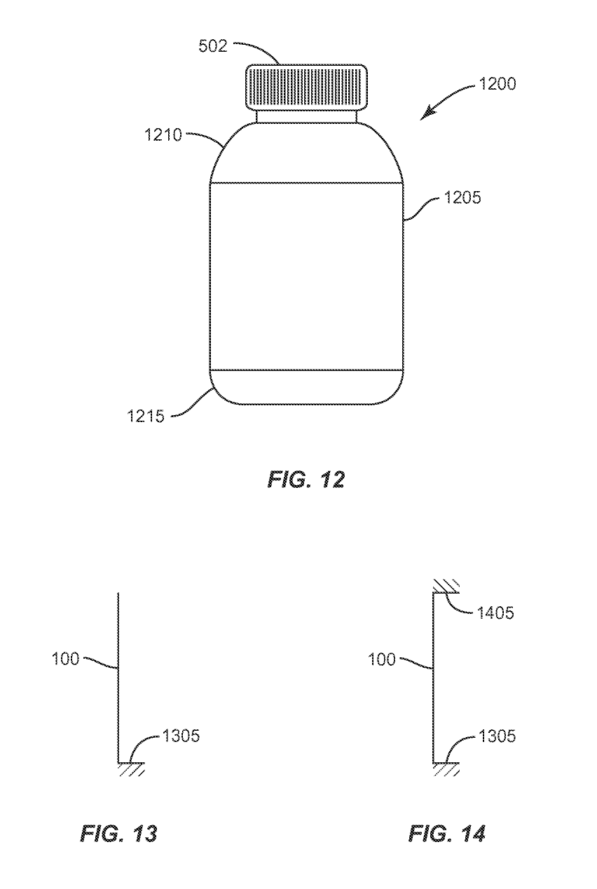

Other containers, however, may not comprise structures to restrain the movement of the label, such as the container 1200 in FIG. 12. The container 1200 may comprise a shoulder 1210, a heel 1215, and a body sidewall 1205 extending between the shoulder 1210 and the heel 1215. In this example, neither the shoulder 1210 nor the heel 1215 extends outward beyond the body sidewall 1205. Thus, a rotating top label 300 applied to this container 1200 may not be held in place and may slip off the container 1200 entirely.

As illustrated schematically in FIGS. 13 and 14, the base label 100 may be constructed to provide the structure to restrict the linear movement of the top label 300. The base label 100 may comprise a first support member 1305 extending outward and generally perpendicular to the front surface 108 of the base label 100 to restrict linear movement of the top label 300 in one direction. For example, the first support member 1305 may be positioned at a bottom edge of the base label 100 to act as a “shelf” for the top label 300. As illustrated in FIG. 14, various embodiments may comprise a first support member 1305 and a second support member 1405 to restrict linear movement of the top label 300 in two directions (e.g., up and down in relation to the container).

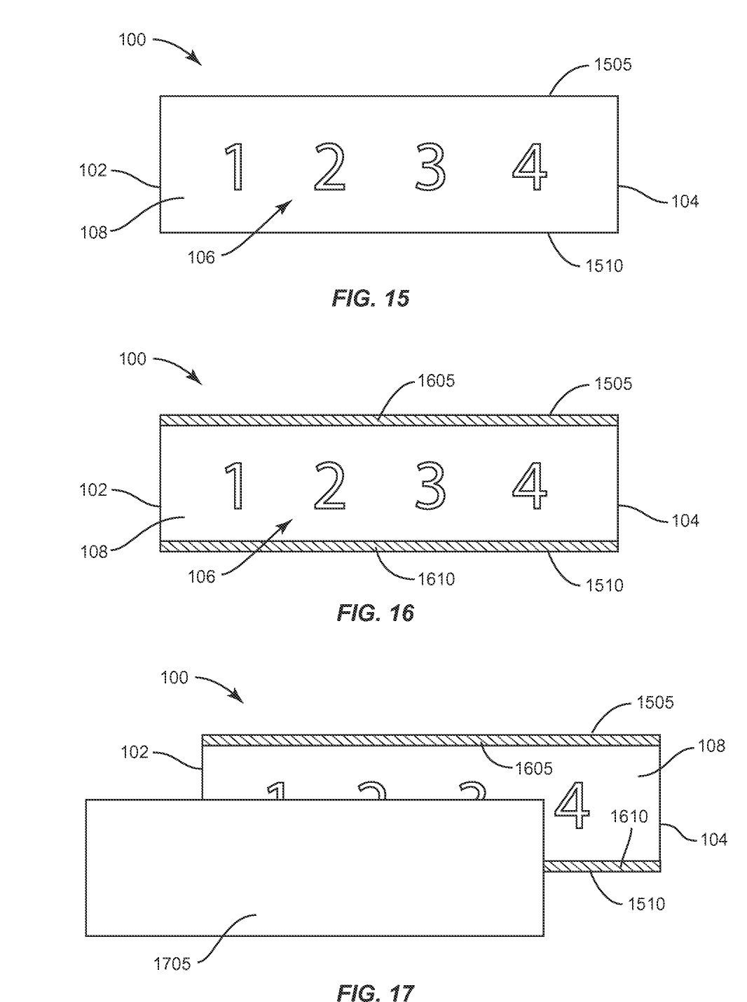

FIG. 15 illustrates the base label 100 according to various embodiments, and may comprise leading edge 102, trailing edge 104, front surface 108, and indicia 106 printed on the front surface as described previously. The base label 100 may also comprise an upper edge 1505 and lower edge 1510 (as used here, “upper” and “lower” simply refer to the orientation of the base label 100 on the container 1200 as shown in the figures for ease of reference).

In order to construct the first and second support members 1305, 1405 on the base label 100 according to various embodiments as illustrated in FIGS. 16 through 19, a first strip of adhesive 1605 may be applied on the front surface 108 of the base label 100 in proximity to the upper edge 1505. A second strip of adhesive 1610 may be applied on the front surface 108 in proximity to the lower edge 1510. A piece of substrate material 1705 may then be placed over the front surface 108 of the base label 100. In various embodiments as illustrated in FIG. 17, the substrate material 1705 may be approximately the same size as the base label 100, although other sizes, both larger and smaller than the base label 100, are within the scope of the present disclosure. The substrate material 1705 may comprise any material known in the art for labels, such as any type of paper or plastic, or combination of materials. In various embodiments, the substrate material 1705 may comprise the same material from which the base label 100 or the top label 300 is constructed.

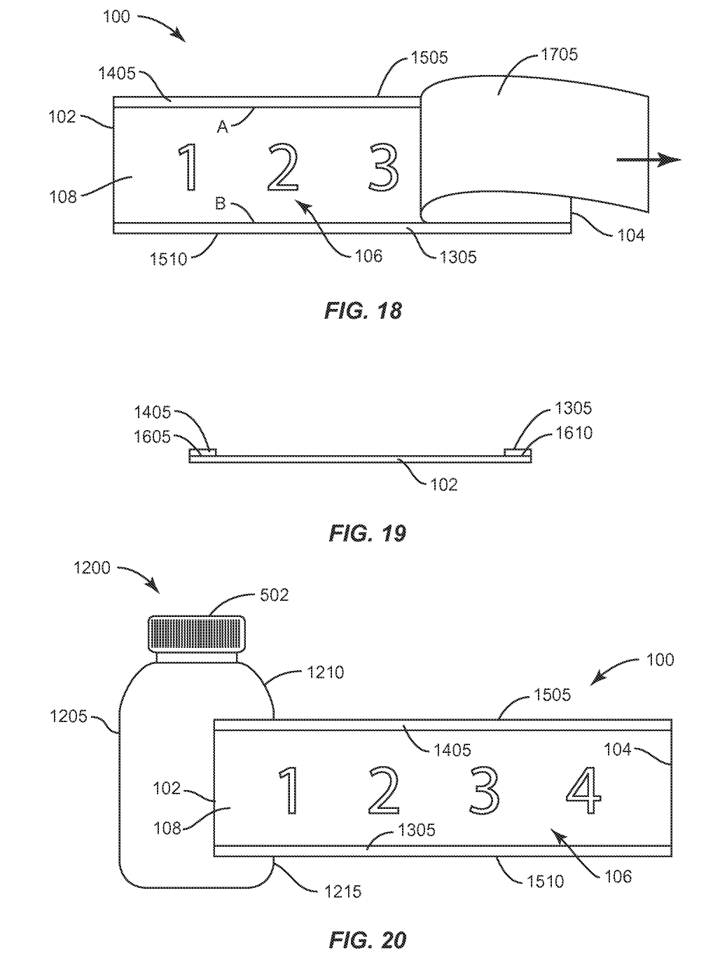

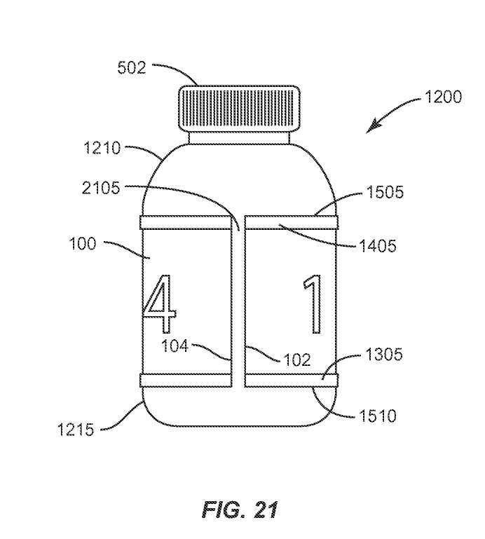

The substrate material 1705 may adhere to the adhesive strips 1605, 1610. The substrate material 1705 may then be scored along lines A and B (see FIG. 18) near the edge of the adhesive strips 1606, 1610. The excess substrate material 1705 may be peeled away, leaving a layer of substrate material 1705 adhered to the adhesive strips 1605, 1610. FIG. 19 shows a side view of the base label 100 according to various embodiments after the excess substrate material 1705 has been removed. The remaining substrate material 1705 on the base label 100 may form the first and second support members 1305, 1405.

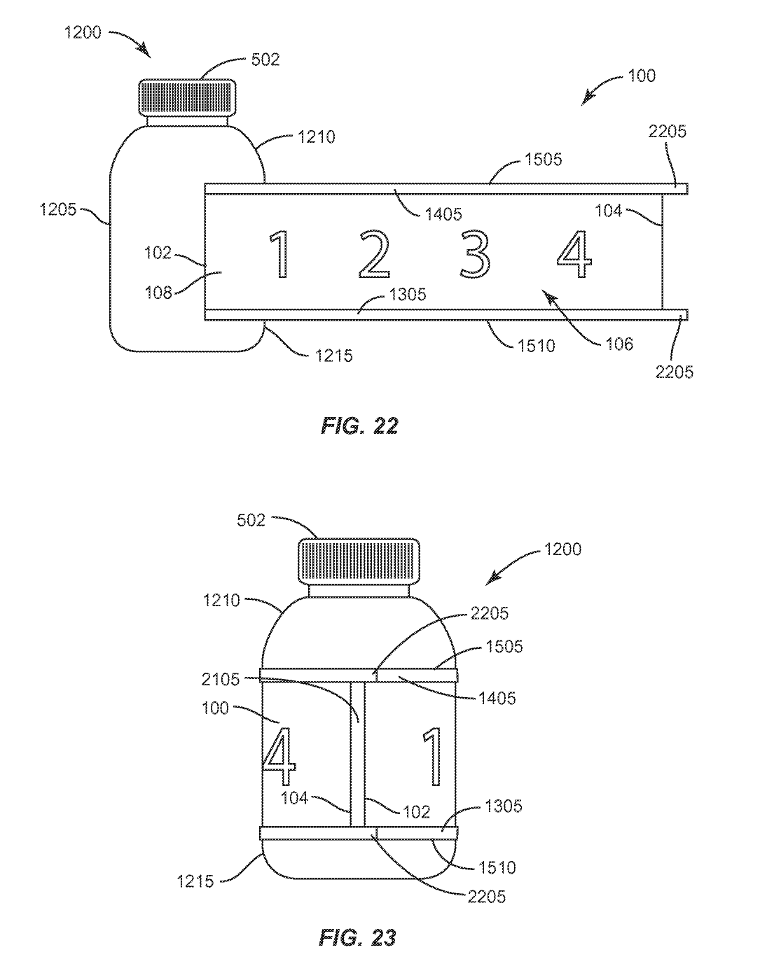

In FIG. 20, the base label 100 may be applied to the container 1200 by first attaching leading edge 102 to the body sidewall 1205 and wrapping the base label 100 about the container 1200. In various embodiments, the trailing edge 104 may not overlap the leading edge 102 leaving a gap 2105 when the base label 100 is applied to the container 1200. In various embodiments as illustrated in FIG. 22, the substrate material 1705 may be longer than the base label 100 such that tabs 2205 are formed when the excess substrate material 1705 is removed after scoring. When the base label 100 is applied to the container 1200, the tabs 2205 may overlap a portion of the first and second support members 1305, 1405, while maintained the gap 2105 between the leading edge 102 and the trailing edge 104.

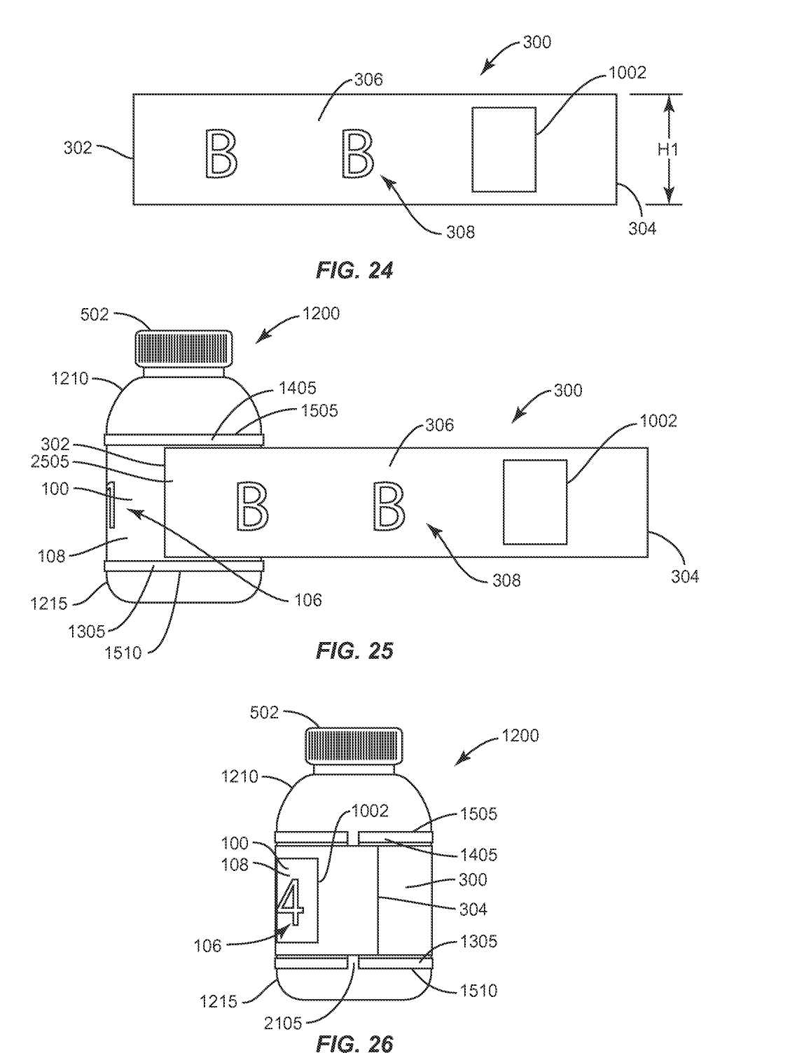

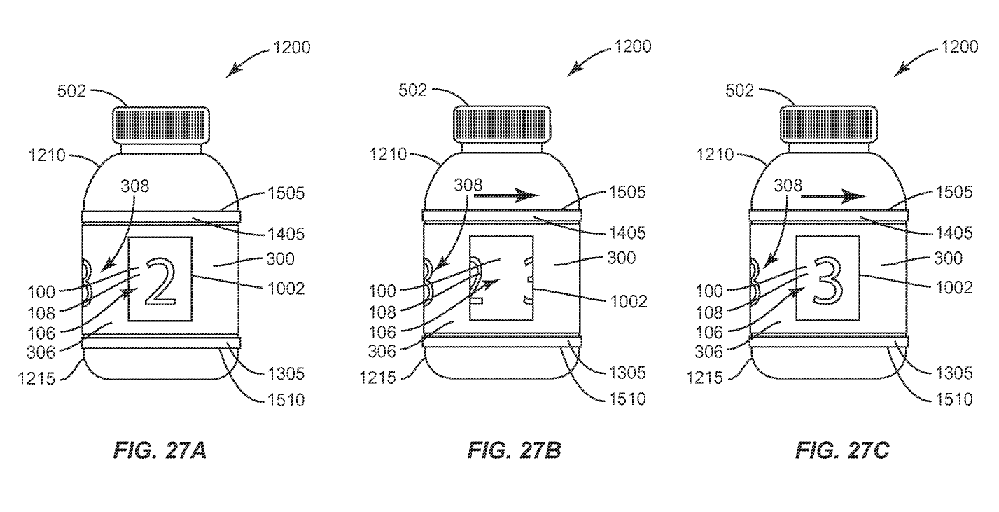

FIG. 24 illustrates a top label 300 comprising a leading edge 302, trailing edge 304, front surface 306 with indicia 308, and one or more transparent windows 1002 as described previously. The top label 300 may have a height H1 selected to fit between the first and second support members 1305, 1405 as illustrated in FIG. 25 according to various embodiments. The top label 300 may have a blank portion 2505 along the leading edge 302 that is essentially void of any indicia 308. As described previously, the trailing edge 304 may overlap the leading edge 302 when the top label 300 is applied to the container 1200. The blank portion 2505 provides a space for attachment of the trailing edge 304 without obscuring any of the indicia 308 as illustrated in FIG. 26. FIG. 26 also illustrates the top label 300 restricted from linear movement along the vertical axis of the container 1200 by the first and second support members 1305, 1405. However, as illustrated by the various embodiments of FIGS. 27A through 27C, the first and second support members 1305, 1405 may not restrict the rotational movement of the top label 300 and may maintain proper positioning of the top label 300 over the base label 100.

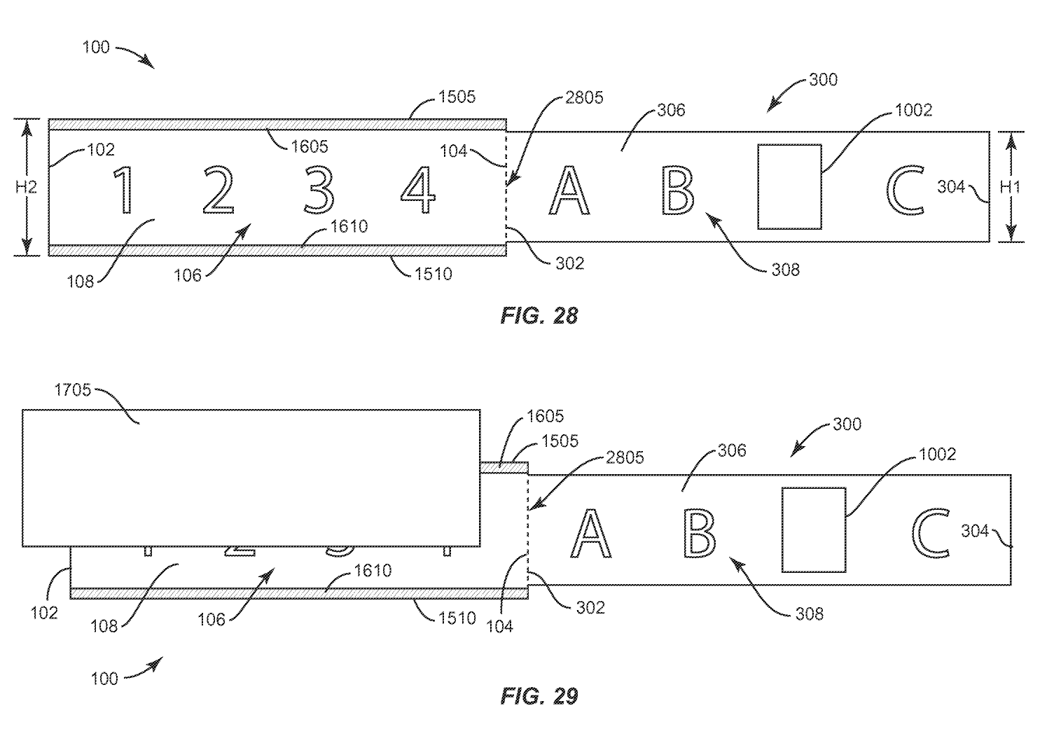

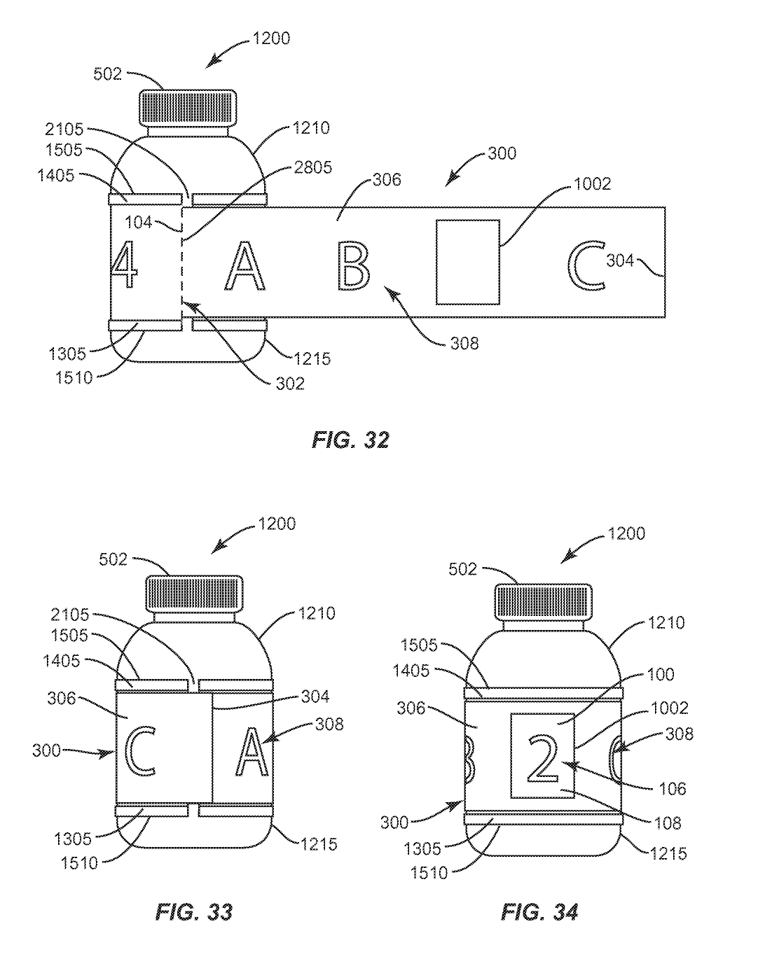

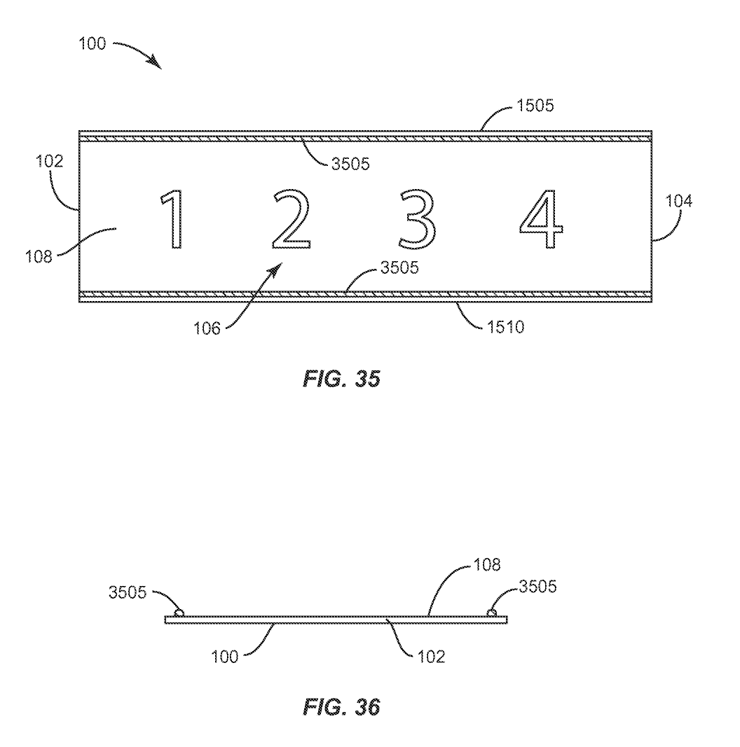

In various embodiments as illustrated in FIG. 28, the base label 100 may be coupled to the top label 300. A perforation 2805 may be formed at the junction of the base label trailing edge 104 and the top label leading edge 302 to facilitate separation of the top label 300 from the base label 100 as described below. The base label 100 may have a height H2, and the top label 300 may have a height H1 that is less than H2. The height H1 of the top label 300 may be selected such that the top label 300 may be positioned between the first and second support members 1305, 1405 when the base label 100 and top label 300 are secured to the container 1200 (see FIG. 32).

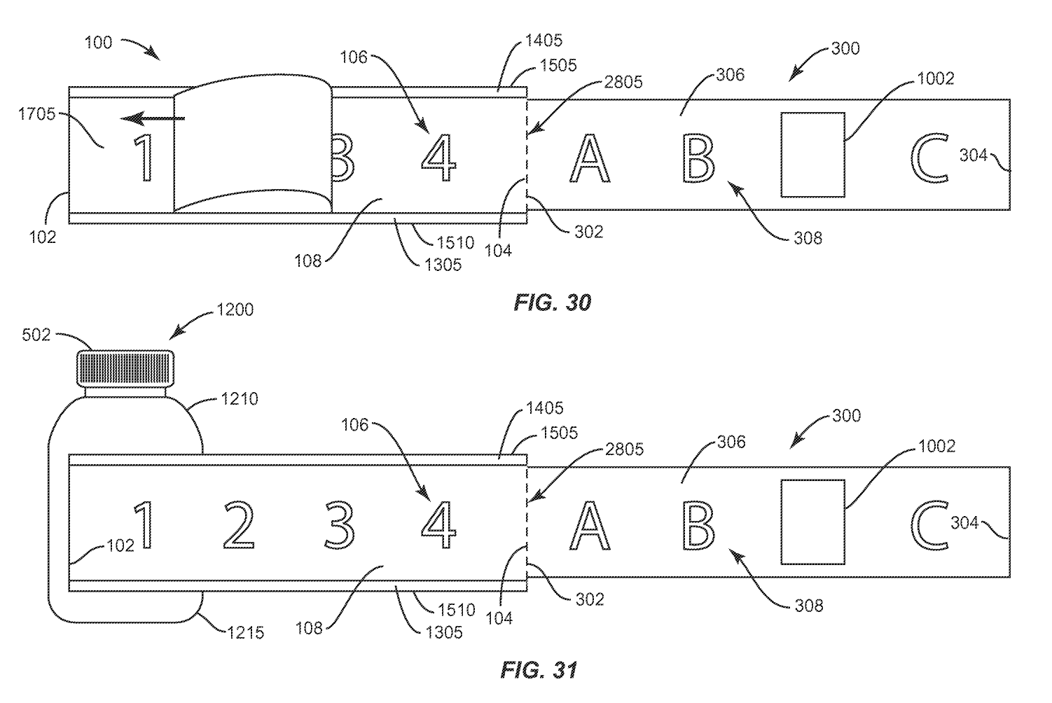

As described above, adhesive strips 1505, 1510 may be placed on the front surface 108 of the base label 100, then substrate material 1705 may be placed over the front surface 108 as illustrated by the various embodiments of FIG. 29. As illustrated in FIG. 30, the substrate material 1705 may be scored and excess substrate material 1705 removed, forming the first and second support members 1305, 1405 on the base label 100. FIG. 31 illustrates the combined base label 100 (with first and second support members 1305, 1405) and top label 300 being secured to the container 1200 beginning with the leading edge 102 of the base label 100. As described previously and illustrated in FIG. 32, the trailing edge 104 of the base label 100 may not overlap the leading edge 102 of the base label 100, leaving a gap 2105. The top label 300 continues to wrap around the container 1200. Because the height H1 of the top label 300 is less than the height H2 of the base label 100, the top label 300 may fit between the first and second support members 1305, 1405 as the top label 300 wraps around the container 1200.

FIG. 33 illustrates the top label 300 wrapped completely around the container 1200 such that the trailing edge 304 of the top label 300 overlaps the leading edge 302 of the top label. In various embodiments, an adhesive may be applied on the blank portion 2505 of the top label 300 for attaching the trailing edge 304. Thus, the top label 300 may not be coupled to the base label 100 other than at the perforation 2805. The top label 300 may then be separated from the base label 100 at the perforation 2805, allowing the top label 300 to freely rotate about the container 1200 while being restrained from linear movement by the first and second support members 1305, 1405.

One skilled in the art will readily recognize that the support members 1305, 1405 may be formed by any process or technique that will result in an area projecting outward from the front surface 108 of the base label 100 and that any such process or technique is within the scope of the present disclosure. For example, as illustrated in FIGS. 28 and 29, one or more layers of a coating 3505 may be applied essentially parallel to the upper and lower edges 1505, 1510 of the base label. As the thickness of the applied coating 3505 increases, a ridge may be formed that extends outward from the front surface 108 of the base label 100 and functions in essentially the same manner as described previously for the support members 1305, 1405. Examples of coatings that may be useful for this purpose include inks used for printing Braille characters, flexographic thermoforming UV curable ink systems, or other coating with sufficient viscosity and solids content to allow the application of relatively thick layers of the coating. FIG. 29 illustrates a side view of the base label 100 after the coating 3505 has been applied and the ridges formed.

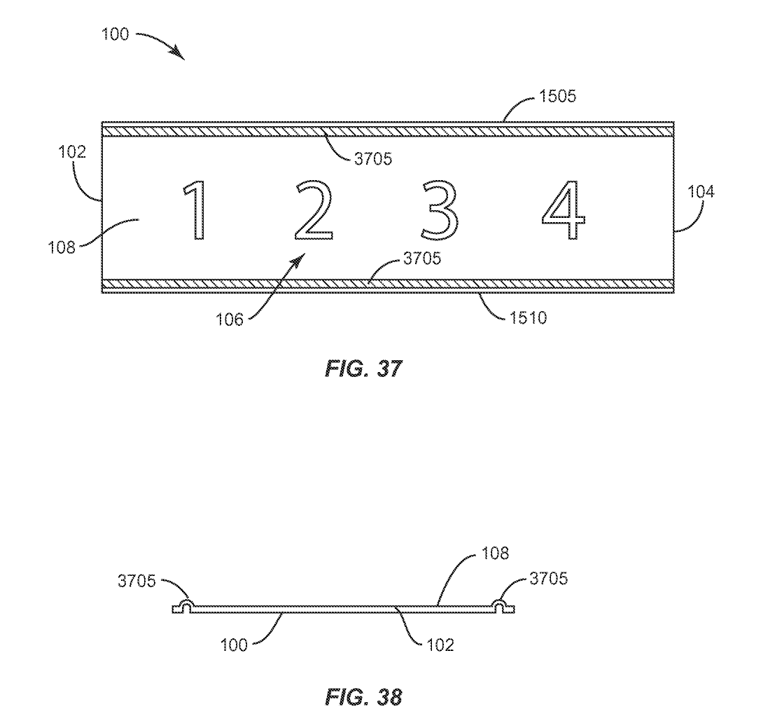

Support members may also be formed by an embossing process as illustrated by the various embodiments of FIGS. 37 and 38. The embossing process may use male and female dies to form a pattern in the base label 100 material. As illustrated in the side view of the base label 100 in FIG. 38, the embossing dies may form a continuous raised ridge 3705 generally parallel to the upper and lower edges 1505, 1510 of the base label 100.

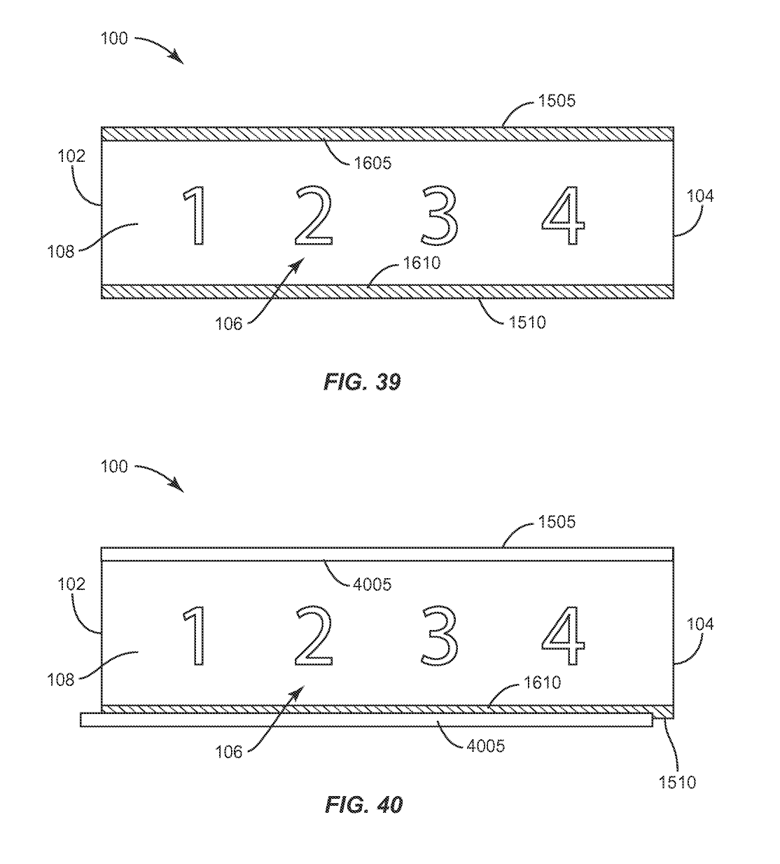

FIGS. 39 and 40 illustrate an alternative to using a sheet of substrate material 1705 to form the first and second support members 1305, 1405. FIG. 39 illustrates the adhesive strips 1605, 1610 applied to the base label 100 as described previously. According to various embodiments as illustrated in FIG. 40, strips of substrate material 4005 may be placed onto the adhesive 1605, 1610 to form the support members. This procedure may eliminate the steps of scoring the substrate material 1705 and removal of the excess substrate material 1705 that may be required when a sheet of substrate material 1705 is used.

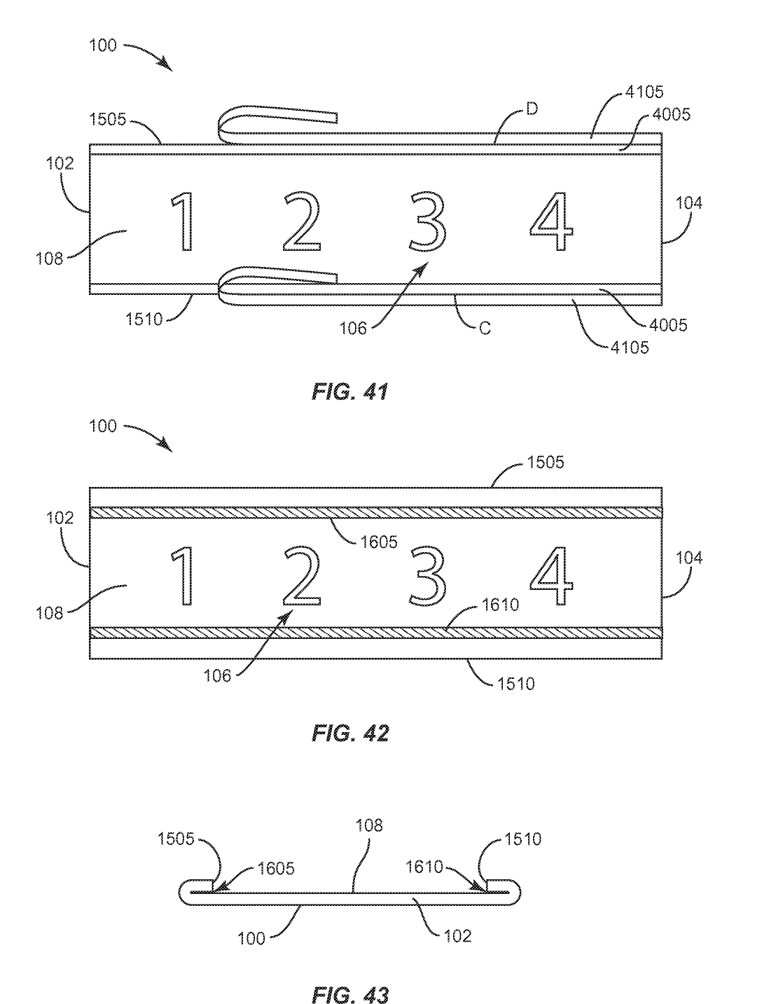

FIG. 40 illustrates various embodiments in which the strips of substrates material 4005 may not overlap the upper and lower edges 1505, 1510 of the base label 100 when applied. In certain embodiments, the strips of substrate material 4005 may be applied such that a portion of one or more of the strips 4005 extends beyond the upper and lower edges 1505, 1510. FIG. 41 illustrates various embodiments in which an excess portion 4105 of the strip of substrate material 4005 extends beyond one or both of the upper and lower edges 1505, 1510. Although in some embodiments the excess portion 4105 may remain attached to the strip of substrate material 4005, the excess portion 4105 may be removed in various embodiments. The strip of substrate material 4005 may be cut or scored along cut lines C and D at or near the upper and lower edges 1505, 1510 of the base label 100 to facilitate removal of the excess portion 4105.

In various embodiments as illustrated in FIGS. 42 and 43, support members may be formed by folding the upper and lower edges 1505, 1510 of the base label 100. In FIG. 42, the adhesive strips 1605, 1610 are placed on the front surface 108 of the base label 100. However, the adhesive strips 1605, 1610 may be spaced somewhat further apart from the upper and lower edges 1505, 1510 than illustrated previously. The upper and lower edges 1505, 1510 may then be folded over as illustrated in FIG. 43 to contact the adhesive strips 1605, 1610.

The embodiments described above generally involve continuous support members 1305, 1405. One skilled in the art will readily recognize that one or both of the support members 1305, 1405 may be discontinuous. For example, FIG. 40 illustrates continuous strips of substrate material 4005 extending from the leading edge 102 to the trailing edge 104. In various embodiments, the strips of substrate material 4005 may be divided into a plurality of separate pieces that are spaced apart when applied to the adhesive strips 1605, 1610, forming a “dashed line” effect rather than a continuous line. Similarly, the embossing process described for FIGS. 37 and 38 could emboss a series of raised dots, line segments, rectangles, or other shapes rather than a continuous line.

The top label 300 may comprise a dual ply (or multi-ply) construction in which a ply in contact with the base label 100 is a material selected for low sliding friction characteristics. The low sliding friction characteristics may enhance the ease of rotating and sliding the top label 300 about the base label 100. In various embodiments, the top label 300 ply in contact with the base label 100 may be coated with a substance to impart the low sliding friction characteristics.

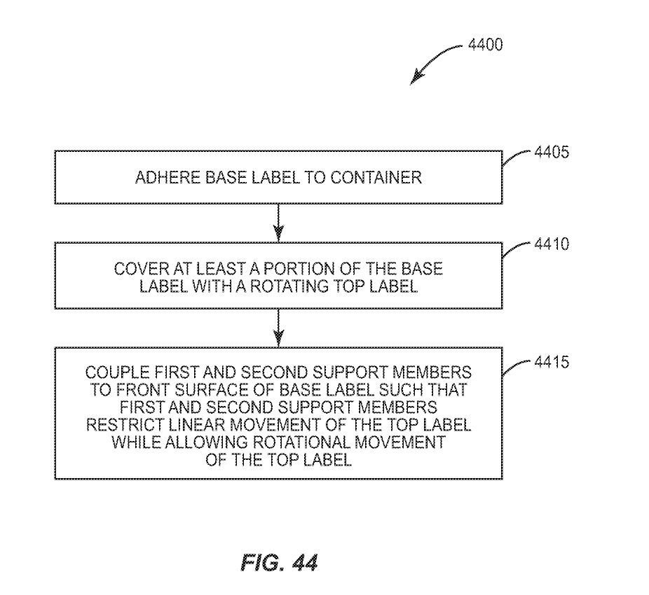

FIG. 44 illustrates a general flow chart of various embodiments of a method 4400 for supporting a rotating label system on a container. A base label 100 may be applied to a container 1200 (step 4405). The base label 100 may have a back surface 206 and a front surface 108. Indicia 106 may be printed or placed on the front surface 108 of the base label 100. At step 4410, at least a portion of the base label 100 may be covered with an opaque rotating top label 300. In various embodiments, the base label 100 may be coupled to the container 1200 while the top label 300 is free to rotate about the base label 100. A transparent window 1002 may be placed within a portion of the rotating top label 300. Various embodiments may comprise more than one transparent window 1002 within the rotating top label. At least a portion of the indicia 106 on the front surface 108 of the base label 100 may be visible through the transparent window 1002. At step 4415, first and second support members 1305, 1405 may be coupled to the front surface 108 of the base label 100. In various embodiments, the first and second support members 1305, 1405 may be positioned adjacent and generally parallel to an upper and lower edge 1505, 1510 of the base label 100. The top label 300 may be positioned between the first and second support members 1305, 1405 such that the first and second support members 1305, 1405 restrict linear movement of the top label 300 while allowing rotational movement of the top label 300.

In various embodiments, all or a portion of the indicia 106 may be imprinted, embossed, or molded directly on an outer surface of the container 1200 in place of all or a portion of the base label 100. The imprinting or embossing may be carried out using any printing or image transfer method known in the art. In various embodiments, the printing or image transfer method may be an offset process in which an image is transferred from a plate to an intermediate carrier, then to the outer surface of the container 1200. The offset process may also involve lithographic techniques. Other printing or image transfer methods may comprise, for example, flexography, pad printing, relief printing, rotogravure, screen printing, and electrophotography. According to various embodiments, the indicia 106 may be digitally printed on the outer surface of the container 1200 using, for example, inkjet printing or laser printing. Chemical printing technologies, such as blueprint or diazo print may also be used in various embodiments.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A rotating label support system for a container, the system comprising:
a base label adhered to the container, the base label having a back surface and a front surface;
an opaque rotating top label covering at least a portion of the front surface of the base label; and
a first support member coupled to the front surface of the base label adjacent to a lower edge of the base label and a second support member coupled to the front surface of the base label adjacent to an upper edge of the base label, the first and second support members restricting linear motion of the top label while allowing rotational movement of the top label.

2. The system of claim 1, wherein each of the first and second support members extend outward from the front surface of the label.

3. The system of claim 1, wherein the first and second support members are essentially parallel with one another.

4. The system of claim 1, wherein each of the first and second support members extend at least partially around a circumference of the container.

5. The system of claim 4, wherein each of the first and second support members extend more than half way around the circumference of the container.

6. The system of claim 1, wherein a thickness of each of the first and second support members is essentially the same as a thickness of the top label.

7. The system of claim 1, wherein a thickness of each of the first and second support members is greater than a thickness of the top label.

8. The system of claim 1, wherein the first and second support members and the top label comprise similar materials.

9. The system of claim 8, wherein the material is paper.

10. The system of claim 8, wherein the material is plastic.

11. The system of claim 1, wherein the first and second support members and the top label comprise dissimilar materials.

12. The system of claim 11, wherein the top label material is paper and the first and second support members comprise one or more layers of a coating.

13. The system of claim 1, wherein at least one of the first and second support members is embossed into the base label.

14. The system of claim 1, wherein the first and second support members are coupled to the front surface of the base label with an adhesive.

15. The system of claim 1, wherein each of the first and second support members comprises a folded edge of base label.

16. The system of claim 1, further comprising at least one transparent window within a portion of the opaque rotating top label, the transparent window allowing at least a portion of the base label to be visible through the transparent window.

17. A rotating label support system for a container, the system comprising:
a base label adhered to the container, the base label having a back surface and a front surface;
first and second support members coupled to opposite edges of the front surface of the base label forming a recessed area therebetween;
an opaque rotating top label positioned within the recessed area such that the first and second support members restrict linear movement of the top label while allowing rotational movement of the top label.

18. The system of claim 17, wherein a lower edge of the top label is adjacent to the first support member, and an upper edge of the top label is adjacent to the second support member.

19. The system of claim 17, wherein each of the first and second support members extend outward from the front surface of the label.

20. The system of claim 17, wherein the first and second support members are essentially parallel with one another.

21. The system of claim 17, wherein each of the first and second support members extend at least partially around a circumference of the container.

22. The system of claim 21, wherein each of the first and second support members extend more than half way around the circumference of the container.

23. The system of claim 17, wherein a thickness of each of the first and second support members is essentially the same as a thickness of the top label.

24. The system of claim 17, wherein a thickness of each of the first and second support members is greater than a thickness of the top label.

25. The system of claim 17, wherein the first and second support members and the top label comprise similar materials.

26. The system of claim 25, wherein the material is paper.

27. The system of claim 25, wherein the material is plastic.

28. The system of claim 17, wherein the first and second support members and the top label comprise dissimilar materials.

29. The system of claim 28, wherein the top label material is paper and the first and second support members comprise one or more layers of a coating.

30. The system of claim 17, wherein at least one of the first and second support members is embossed into the base label.

31. The system of claim 17, wherein the first and second support members are coupled to the front surface of the base label with an adhesive.

32. The system of claim 17, wherein each of the first and second support members comprises a folded edge of the base label.

33. The system of claim 17, further comprising at least one transparent window within a portion of the opaque rotating top label, the transparent window allowing at least a portion of the base label to be visible through the transparent window.

34. A method for supporting a rotating label system on a container, the method comprising:
adhering a base label to the container, the base label having a back surface and a front surface;
covering at least a portion of the front surface of the base label with an opaque rotating top label; and
coupling a first support member to the front surface of the base label adjacent to a lower edge of the base label and coupling a second support member to the front surface of the base label adjacent to an upper edge of the base label, the first and second support members restricting linear motion of the top label while allowing rotational movement of the top label.

35. The method of claim 34, wherein each of the first and second support members extend outward from the front surface of the label.

36. The method of claim 34, wherein each of the first and second support members extend at least partially around a circumference of the container.

37. The method of claim 34, wherein the first and second support members and the top label comprise similar materials.

38. The method of claim 37, wherein the material is paper.

39. The method of claim 37, wherein the material is plastic.

40. The method of claim 34, wherein the first and second support members and the top label comprise dissimilar materials.

41. The method of claim 40, wherein the top label material is paper and the first and second support members comprise one or more layers of a coating.

42. The method of claim 40, wherein at least one of the first and second support members is embossed into the base label.

43. The method of claim 34, wherein the first and second support members are coupled to the front surface of the base label with an adhesive.

44. The method of claim 34, wherein each of the first and second support members comprises a folded edge of the base label.

45. The method of claim 34, further comprising placing at least one transparent window within a portion of the opaque rotating top label, the transparent window allowing at least a portion of the base label to be visible through the transparent window.
